(19) United States
(12) Patent Application Publication
(10) Pub. No.: US 2002/0153060 A1
(43) Pub. Date: Oct. 24, 2002

(54) Methods of making pillows

(76) Inventor: Victorina Vizcarra Amalingan, Makati City (PH)

Correspondence Address: Richard P. Berg, c/o LADAS & PARRY, Suite 2100, 5670 Wilshire Boulevard, Los Angeles, CA, 90036-5679, US

(21) Appl. No.: 10/012,090

(22) Filed: Nov. 6, 2001

(30) Foreign Application Priority Data
Nov. 6, 2000 (PH) 1-2000-0002981
Nov. 6, 2000 (PH) 1-2000-0002982
Nov. 6, 2000 (PH) 1-2000-0002983

(51) Int. Cl. B27J 7/00

(52) U.S. Cl. 144/333

(57) ABSTRACT

The invention provides methods of making pillows using rattan reeds. Novel methods of weaving such as DIKIN method of making lips of the pillows and “base-to-base” method in keeping the shapes and contours of the pillows are described. By using methods disclosed herewith, seamless pillows can be made in a simple manner.

### FIELD OF THE INVENTION

The present invention relates generally to weaving methods, and more particularly, to methods of making rattan pillows using rattan reeds.

### INCORPORATION BY REFERENCE

Please incorporate by reference contents of the Philippine Patent Applications Serial Nos. 1-2000-0002981, 1-2000-0002982 and 1-2000-0002983 filed on Nov. 6, 2000 by the same applicant of the present application. Copies of these applications are submitted herewith.

### BACKGROUND OF THE INVENTION

Handicrafts and weaving methods have existed for at least hundreds of years and are featured in the indigenous culture of the Philippines. With a higher standard of living and more intense competition of products in today's world, however, the traditional weaving techniques have often been proven to be inadequate. For example, by using the traditional weaving techniques, the shapes and contours of the end products are often difficult to maintain. The starting points and ending points of the weaving can often be seen from the exposed ends of the reeds and these are unsightly. Making of laces is often too complicated and thus not efficient.

A conventional pillow is made from a cloth casing which is filled with a pillow filler. The pillows of the present invention are made from a woven fibrous material such as rattan reeds.

### SUMMARY OF THE INVENTION

One object of the present invention is to provide a novel method of making pillows that can easily form the casing of a pillow in a facile fashion.

Another object of the present invention is to provide a method of making pillows by using fibrous materials such as rattan reeds which are cheap, easily available, and have low thermal conductivity and other good qualities such as being comfortable, long-lasting, and ventilative.

Another object of the present invention is to provide a method of making pillows whose shape and contour are easy to maintain.

Another object of the present invention is to provide a method of making pillows wherein the starting points and ending points of weaving cannot be seen from outside of the end products.

Another object of the present invention is to provide a method of making seamless pillows.

Another object of the present invention is to provide a method of making pillows having laces that are easy to make.

These and other objects of the present invention will be better understood upon reading of the following detailed description taken in conjunction with the appended drawings.

### BRIEF DESCRIPTION OF THE DRAWINGS

FIG. 1 is a block diagram of a series of steps of a first embodiment of making the pillows.

FIG. 2 is a block diagram of a series of steps of a second embodiment of making the pillows.

FIG. 3 is a block diagram of a series of steps of a third embodiment of making the pillows.

### BRIEF DESCRIPTION OF THE APPENDICES

Appendices pages A1 to A10 are photocopies of photographs showing various steps of making rattan pillows and the end products produced by using the steps as described in the embodiments of the present invention and the documents incorporated by reference. Enclosed please also find models of the rattan pillows made by using the steps described in the present application.

### DETAILED DESCRIPTION OF THE INVENTION

The First Embodiment

The first embodiment of the present invention provides a method of making pillows using an unique DIKIN method to form lips or laces of the pillows. The materials used are mainly a plurality of elongated fibrous strands such as rattan reeds. The fibrous strands are used as guide reeds, vertical spokes, and weaving strands. A pillow mold is used to form the shape of the pillow. Shape of the pillow mold decides shape of the pillow casing and the completed pillow. A pillow filler is filled into the pillow casing to form the pillow. Nylon cords are preferably used in this embodiment to sew together lips of the pillow casing.

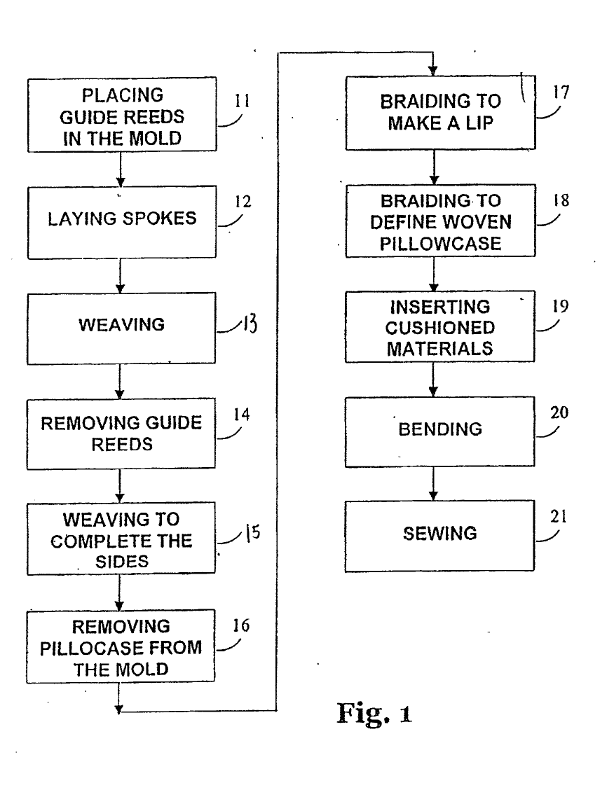

Referring now to FIG. 1, a block diagram illustrates the step-by-step series of the first embodiment of making the pillows. Making of the pillow starts with folding a rattan reed into two guide reeds and placing the guide reeds horizontally around the pillow mold, as shown in step 11. Subsequently, vertical spoke reeds, which are rattan reeds in suitable lengths, are placed one by one in between the guide reeds, as shown in step 12. The vertical spoke reeds are placed in perpendicular to the guide reeds. Preferably, after laying every two spoke reeds, the guide reeds are twisted for at least 180 degrees to stabilize the spoke reeds.

After all the spoke reeds are laid in between the guide reeds surrounding the pillow mold, begin weaving as listed in step 13 by placing rattan strands in an over-and-under pattern, i.e. over one spoke reed, then under the next spoke reed, then over the following spoke reed, and so on, until the entire rattan strand has been weaved into the spoke reeds. If the spoke reeds are placed in a circle around the pillow mold, the woven rattan strand should also be around the pillow mold and form a circle parallel to the ground. If the rattan strand is longer than the perimeter of the pillow mold, then continue weaving the strand into another circle, adjacent to the first circle, around the pillow mold, until the entire rattan strand has been weaved into the spoke reeds. Preferably, the two ends of the rattan strand should be hidden inside the pillow casing so that no free ends could be seen from outside the pillow casing. After finishing weaving one rattan strand, weave another rattan strand adjacent to the first one, in the same way the first strand is woven. Then start weaving another rattan strand, and so on, in uniform distances.

After a number of rattan strands are woven into the spoke reeds, the spoke reeds are stable. As shown in step 14, the guide reeds are then removed. The gap formed from removing the guide reeds are filled by weaving new rattan strands into the gap, in the same over-and-under pattern.

As shown in step 15, continue weaving until the side of a pillow casing is formed and completed. The shape and size of the side of the pillow casing depend largely on the shape and size of the pillow mold. Then the pillow mold can be removed from the pillow casing, as shown in step 16.

Subsequently, lips or laces of the pillow casing are made using a novel “DIKIN” method. The DIKIN method is a weaving technique of braiding sideways the unwoven portions of the vertical spokes to form the lips or laces of the pillow casing. The unwoven portions of the vertical spokes are bent sideways and braided together like a rope or a queue. These steps are shown in steps 17 and 18 of FIG. 1.

A pillow filler should then be inserted into the pillow casing as shown in step 19. The pillow filler could be made of cushioned materials, such as crushed foam, fiber fill, or even herbs. The pillow filler could be inserted either after the lips are completed or before the lips are completed. After the pillow filler is inserted, bend the lips together at both edges of the pillow casing and sew the lips together with nylon cords to close the edges of the pillow casing, as shown in steps 20 and 21 of FIG. 1.

This embodiment may be implemented without use of a pillow mold by a worker with sufficient skills.

The Second Embodiment

The second embodiment of the present invention provides a method of making pillows in a log-shape or a cylindrical shape. The materials used are mainly a plurality of elongated fibrous strands such as rattan reeds. The fibrous strands are used as spokes and weaving strands. A log-shaped pillow mold is used to form the shape of the pillow. Size of the pillow mold decides size of the pillow casing and the completed pillow. A pillow filler is filled into the pillow casing to form the pillow. Nylon cords are not required in this embodiment.

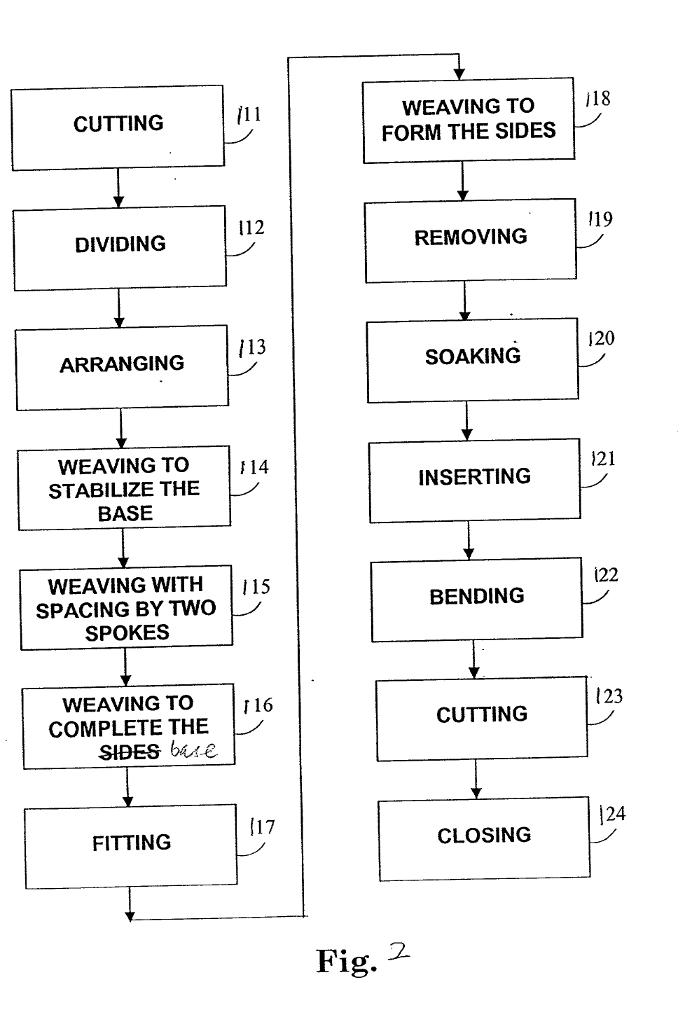

FIG. 2 is a block diagram that illustrates the step-by-step series of the second embodiment of making the pillows. Making of the pillow in this embodiment starts with cutting of rattan reeds into equal lengths to be used as spokes, as shown in step 111 of FIG. 2. The length of the spokes depends on the desired length of the log-like pillow being produced. The spoke reeds are then divided into four groups, as shown in step 112. Each group of spoke reeds, for example, may contain four to six rattan reeds. The four groups of spoke reeds are placed on top of one another to form eight radial spokes of a circle, as shown in step 113. Centers of different groups of reeds intersect at a first pivot point, or the center of the circle. The eight radial spokes divide the circle approximately evenly. Thus, every two adjacent radial spokes form an angle of approximately 45 degrees.

Starting from the first pivot point, start weaving rattan strands, one by one, around the radial spokes in the over-and-under pattern described above. The weaving can have many different patterns. For example, one may first weave over-and-under the radial spokes (each having four to six rattan reeds) for two turns to stabilize the base, as shown in step 114. Then, the radial spokes with four to six rattan reeds each can be divided into smaller spokes with two rattan reeds each. The weaving then continues over-and-under these smaller spokes. Alternatively, each radial spoke may have same number (such as two or four) of rattan reeds throughout the weaving process. The number of rattan reeds contained in each spoke and the spacing of weaving can be adjusted in view of the size of the pillow casing or the rattan reeds, or other factors. As a preferred embodiment, step 115 shows weaving with spacing by two spokes.

Continue weaving until a circular base of the pillow casing is formed, as shown in step 116. Adjust tension of the weaving strands so that the base will be slightly bent upward. Fit this bent circular base onto a log-shaped pillow mold, as shown in step 117. Then, continue weaving in accordance with the pillow mold until forming the side of a log-like pillow casing with one end open, as shown in step 118. Now, the pillow mold can be removed from the pillow casing and the pillow filler can be inserted into the pillow casing, as shown in steps 119 and 121. Preferably, the free ends of the spoke reeds should be soaked into water to make the spokes more pliable, as shown in step 120, before inserting the pillow filler.

After the pillow filler is inserted, bend the free ends of the spoke reeds together, as shown in step 122, until opposing spoke reeds intersect each other at a second pivot point, or the center of the top surface of the pillow casing. Cut excess length of the spoke reeds, as shown in step 123, so that the free ends of the reeds are even and inserting the free ends into the pillow casing so that the free ends will not be seen from outside. Then, starting from the second pivot point, weave rattan strands one by one to close the top surface of the pillow casing, as shown in step 124, in the same way the base is formed.

This embodiment may be implemented without use of a pillow mold by a worker with sufficient skills.

The Third Embodiment

The third embodiment of the present invention provides a method of making pillows in a rectangular or square shape. The materials used are mainly a plurality of elongated fibrous strands such as rattan reeds. The fibrous strands are used as side spokes, edge spokes and weaving strands. A rectangular-shaped or square-shaped pillow mold is used to form the shape of the pillow. Size of the pillow mold decides size of the pillow casing and the completed pillow. A pillow filler is filled into the pillow casing to form the pillow. Nylon cords are not required in this embodiment.

FIG. 3 is a block diagram that illustrates the step-by-step series of the third embodiment of making the pillows. Making of the pillow in this embodiment starts with preparing three groups of rattan reeds, as shown in step 211, having a group of reeds of a shorter length to be used as side spokes, a group of reeds of a longer length to be used as edge spokes, and a group of reeds of an uncut length to be used for weaving. Lengths of the spoke reeds depend on the desired size of the pillow. Preferably, the shorter rattan reeds used as side spokes are about ¾ the length of the longer rattan reeds. The uncut rattan reeds are approximately double the length of the longer reeds. There should be an even number of spoke reeds for the base.

Subsequently, mark centers of the spoke reeds as shown in step 212. Beginning from the mark centers, lay down the edge spokes, as shown in step 213, perpendicularly to the side spokes in the over-and-under pattern described above. Continue laying the edge spokes and side spokes in the over-and-under pattern until a base of a pillow casing is formed and completed, as shown in step 214. To stabilize the base, begin weaving from one corner of the base and weave around the edge and side spokes in the over-and-under pattern for at least two turns, as shown in step 215.

After the base of the pillow casing is completed, lay the base over a pillow mold in a rectangular shape or a square shape, as shown in step 216. The base is preferably one inch longer or bigger all around than the pillow mold to give enough space to easily insert or take out the pillow mold. Afterwards, bend the remaining portions of the edge spokes and side spokes towards the pillow mold so that the remaining portions of the spokes are perpendicular to the base. Then, use the group of reeds of the uncut length to weave around the spokes in the over-and-under pattern until the side of the pillow casing is completed, as shown in step 217. After forming the side, the pillow mold should then be removed and a pillow filler of suitable size should be inserted, as shown in steps 218 and 220. Preferably, before inserting the pillow filler, the free ends of the spokes of the pillow case should be soaked in water to make the spokes more pliable, as shown in step 219. After the pillow filler is inserted, bend the free ends of the spokes together until opposing spokes intersect each other, as shown in step 221. Then, cut excess portions of the spokes and weaving the spokes together, in the same way the base is formed, until the pillow casing is closed, as shown in steps 222 and 223.

This embodiment may be implemented without use of a pillow mold by a worker with sufficient skills.

The weaving techniques described in the second embodiment and the third embodiment of the present invention are sometimes referred as “base-to-base” method. By using this method invented by the inventor, the shape and contour of the pillow casings, which are very difficult to maintain, can indeed be maintained.

The embodiments described in detail for exemplary purposes are of course subject to many different variations in structure, design and application. Since many varying and different embodiments may be made within the scope of the inventive concepts herein taught, and since many modifications may be made in the embodiment herein detailed in accordance with the descriptive requirements of the law, it is to be understood that the detailed embodiments provided above are to be interpreted as illustrative and not in a limiting sense.

[image]

[image]

[image]

[image]

[image]

[image]

[image]

[image]

[image]

[image]

I claim:

1. A method of making a pillow, comprising the steps of:
folding a rattan reed into two guide reeds;
laying vertical spoke reeds, one by one, in between the guide reeds, the vertical spoke reeds being perpendicular to the guide reeds;
beginning weaving rattan strands, one by one, around the vertical spoke reeds in an over-and-under pattern, until the vertical spoke reeds are stable;
removing the guide reeds;
continuing weaving until the side of a pillow casing is formed and completed;
at each edge of the pillow casing, bending remaining portions of the vertical spoke reeds sideways and braiding the remaining portions together in a rope-shape to form a continuous lip of the pillow casing;
inserting a pillow filler into the woven pillow casing;
bending the lips together at both edges of the pillow casing; and
sewing the lips together with nylon cords to close the edges of the pillow casing.

2. The method of making a pillow in claim 1, further comprising a step of
after laying every two spoke reeds, the guide reeds are twisted for at least 180 degrees to stabilize the spoke reeds.

3. The method of making a pillow in claim 1, further comprising the steps of
after folding a rattan reed into two guide reeds, placing the guide reeds horizontally around a pillow mold; and
before the pillow filler is inserted, removing the woven pillow casing from the pillow mold.

4. A method of making a lip of a pillow casing, comprising the steps of
weaving an open-ended pillow casing comprising an edge and weaving spokes having remaining portions extending out of the edge; and
at the edge of the pillow casing, bending the remaining portions of the weaving spokes sideways and braiding the remaining portions together in a rope-shape to form a continuous lip of the pillow casing.

5. A method according to claim 4, wherein the weaving spokes are rattan reeds and the pillow casing is made of rattan reeds.

6. A method of making a log-like pillow, comprising the steps of
dividing rattan reeds into a plurality of groups of reeds;
arranging the plurality of groups of reeds circularly, one on top of another to form a plurality of radial spokes, wherein centers of different groups of reeds intersect at a first pivot point;
starting from the first pivot point, beginning weaving rattan strands around the radial spokes in an over-and-under pattern until forming a bent circular base;
continuing weaving in the over-and-under pattern until forming the side of a log-like pillow casing with one end open;
inserting a pillow filler into the pillow casing;
bending the free ends of the spokes together until opposing spokes intersect each other at a second pivot point;
cutting excess length of the spokes and inserting the free ends of the spokes into the pillow casing;
starting from the second pivot point, weaving rattan strands around the radial spokes in the over-and-under pattern until the pillow casing is completed.

7. The method of making a log-like pillow according to claim 6, further comprising the steps of
after the circular base is formed, fitting the circular base onto a log-shaped pillow mold; and
before inserting the pillow filler, removing the pillow casing from the mold.

8. The method of making a log-like pillow according to claim 6, wherein each radial spoke comprising two rattan reeds.

9. A method of making a log-like pillow, comprising the steps of:
cutting rattan reeds into equal lengths;
dividing the reeds into four groups;
arranging the four groups of reeds circularly, one on top of another to form eight radial spokes, wherein centers of different groups of reeds intersect at a first pivot point and every two adjacent radial spokes form an angle of approximately 45 degrees;
starting from the first pivot point, beginning weaving rattan strands, one by one, around the radial spokes in an over-and-under pattern for at least two turns to stabilize the radial spokes;
continuing weaving but spacing the over-and-under pattern by two spokes for several turns until the spokes bend inward;
continuing weaving but spacing the over-and-under pattern by at least three spokes until forming a bent circular base;
fitting the circular base onto a log-shaped pillow mold;
continuing weaving in the over-and-under pattern until forming the side of a log-like pillow casing with one end open;
removing the pillow casing from the mold;
inserting a pillow filler into the pillow casing;
bending the free ends of the spokes together until opposing spokes intersect each other at a second pivot point;
cutting excess length of the spokes so that the free ends of the spokes are even and inserting the free ends of the spokes into the pillow casing so that the free ends will not be seen from outside;
starting from the second pivot point, weaving rattan strands, one by one, around the radial spokes in the over-and-under pattern for at least two turns; and
continuing weaving but gradually increasing the spacing of the over-and-under pattern by two spokes and by three spokes until the pillow casing is completed.

10. The method of making a log-like pillow in claim 9, wherein each group of reeds comprises four to six reeds.

11. The method of making a log-like pillow in claim 9, further comprising a step of soaking the free ends of the spokes of the pillow casing in water to make the spokes more pliable before inserting the pillow filler.

12. The method of making a log-like pillow in claim 9, wherein the free ends of the spokes and the rattan strands are hidden inside the pillow casing and cannot be seen from outside the pillow casing.

13. The method of making a log-like pillow in claim 9, wherein when all the steps are finished, by looking at the completed pillow, one cannot tell where the weaving starts or where the weaving ends.

14. A method of making a rectangular pillow, comprising the steps of
preparing three groups of rattan reeds, comprising a group of reeds of a shorter length to be used as side spokes, a group of reeds of a longer length to be used as edge spokes, and a group of reeds of an uncut length to be used for weaving;
placing the side spokes, side by side, in parallel to each other;
laying the edge spokes perpendicularly to the side spokes in an over-and-under pattern;
continuing laying the edge spokes and side spokes in the over-and-under pattern until a base of a pillow casing is formed and completed;
bending the remaining portions of the edge spokes and side spokes towards the pillow mold so that the remaining portions of the spokes are perpendicular to the base;
using the group of reeds of the uncut length to weave around the spokes in the over-and-under pattern until a side of the pillow casing is completed;
inserting a pillow filler into the pillow casing;
bending the free ends of the spokes together until opposing spokes intersect each other;
cutting excess portions of the spokes; and
weaving the spokes together, in the same way the base is formed, until the pillow casing is closed.

15. The method of making a rectangular pillow in claim 14, further comprising the steps of
after the base of the pillow is formed and completed, laying the base over a pillow mold in a rectangular shape; and
before the pillow filler is inserted, removing the pillow mold from the pillow casing.

16. The method of making a rectangular pillow in claim 14, further comprising a step of weaving around the base in a circular way for at least two turns, in the over-and-under pattern, to stabilize the base after the base is formed.

17. The method of making a rectangular pillow in claim 14, further comprising a step of soaking the free ends of the spokes of the pillow casing in water to make the spokes more pliable before inserting the pillow filler.
